(19) United States
(12) Patent Application Publication
(10) Pub. No.: US 2005/0084173 A1
(43) Pub. Date: Apr. 21, 2005

(54) Laminograph deshadowing

(76) Inventor: David R. Smith, San Jose, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/687,179

(22) Filed: Oct. 15, 2003

(51) Int. Cl. G06K 9/42

(52) U.S. Cl. 382/256

(57) ABSTRACT

A method for deshadowing a laminographic image comprises selecting a mathematical morphology structuring element larger than examination elements of a laminographic image to be inspected, performing a mathematical morphological operation on said image, and differentiating a background of said image from said examination elements to remove said background. The mathematical morphological operation may be a dilation or a closing for a positive image. For a negative image the mathematical morphological operation may be an erosion or an opening. Embodiments call for the use of a power of two structuring element, a bi-directional power of two structuring element, a terraced structuring element, or a sloped structuring element. The mathematical morphological operation may comprise at least one piecewise linear dilation or erosion by a structuring element of limited support. Thresholding may be used to provide a deshadowed binary image.

### TECHNICAL FIELD

The present invention is generally related to inspection of images, and more specifically, to laminograph deshadowing.

### BACKGROUND OF THE INVENTION

“Laminography” includes a wide variety of imaging techniques. There are known in the art a number of imaging methods, which are referred to herein as laminography, that carry out “2-1/2 dimensional” imaging. In laminography, some sort of energy, for example, electromagnetic radiation or acoustic waves, is directed through a region containing object(s) of interest. The energy is sensed using one or more stationary or moving sensors. The sensors may contain multiple sensing elements arranged in a line, grid, or some other regular or irregular pattern. The sensor outputs, which shall be referred to herein as images, taken at various times and positions are typically combined using linear or nonlinear averaging operation(s). These averaging operations typically use analog, digital, or software means, to produce one or more slices through the objects. A slice may not be perfectly planar, but each is approximately 2 dimensional. Each slice may be viewed as a 2 dimensional map of density, transparency, temperature, color, or some other physical property of the objects that affects the passage of the energy used in the sensing process. Laminography is often referred to as “2-½ dimensional” because multiple slices can be used to approximate a 3 dimensional reconstruction of the objects. In this way, laminography is different from tomography, in that in tomography a complete 3 dimensional reconstruction of the objects is obtained. In order to do this, tomography is generally more difficult and time-consuming that laminography. However, the disadvantage of laminography corresponding to this speed and complexity advantage is that laminographs often contain shadows of out-of-slice objects.

To ensure quality, electronic circuit boards and the like may require automated inspection after manufacture to ensure that component solder joints are satisfactory. Many joints may be inaccessible to line-of-sight optical imaging, which leads to the use of X-ray imaging, acoustical imaging, or the like. While such images may provide a view of joints, such as ball grid arrays, which are out of line-of-sight, such as under components, these images also pick up details internal to a printed circuit board (PCB), such a conductive traces, as well as components on the opposite side of the circuit board. Joints from opposite side components on a board may overlay subject joints, partially or totally, in an image, corrupting quality assessments. As a result, laminography may be employed for solder joint inspection.

Laminography focuses on a plane containing solder joints of interest, while the joints and components from the other side of the board are thrown out of optical focus. In the plane of a solder joint, each joint is typically adjacent to circuit board that has no solder or opaque components. As shown in FIG. 1, typical previous laminograph 100 shows PCB conductive traces and opposite side solder and components as blurred out into regions of shadows 102 which are large, relative to the size of solder joints 101 under inspection. Solder joints 101 are notably more highly absorptive of X-rays than circuit board 103. Thus, joints 101 are darker than their surroundings in an X-ray image.

A laminograph, radiograph or similar image may be viewed as constructed of dense objects distributed across a plane. Analysis of the objects is complicated by variations in intensity, caused by factors, such as variable system gain across an image due to nonorthogonal projection and the aforementioned out-of-focus objects that are out of the plane of focus. As a result, in a PCB example, solder joint images are superimposed on a variegated sea of unfocused shadows of PCB traces and opposite-side component shadows. However, since human vision selectively separates salient information from unimportant information, to the human eye, the in-plane joints stand out, while components on the opposite side are rendered indistinct. However, computer algorithms, have much more difficulty making such distinctions. Furthermore, sensor gain may vary across images in a manner that may change over time due to laminograph equipment component aging and laminograph equipment damage from X-rays or the like.

Use of laminography is not widespread, particularly for solder joint inspection. Existing laminographic inspection equipment, such as an AGILENT® 5DX™, attempts to compensate for background levels by determining an approximate joint location by corresponding a scan of a PCB and a computer aided drafting (CAD) description of the circuit board's design.

Alternatively, modeling of interfering components' expected contribution to a laminographic image, and subtraction or division of the interfering components, out of the actual image might take the form of a “golden image”. This “golden image” might be obtained by imaging a board that has been manufactured without the components to be tested (i.e., the components on the other side of the board are present and soldered). Different testing machines, even of the same model, may differ from each other, so the golden board will have to be scanned by each individual machine. Additionally, such a golden image cannot be prepared from a CAD file because such a file will not model exact physical shapes internals and intervals.

With either of these compensation schemes changes in registration can cause artifacts, and registration correction can requires significant processing time. Furthermore, variability of appearance of parts employed may cause variances in an image relative to the golden image or CAD layout. Additionally, some components, such as coil cores or tantalum caps, may shift relative to a “golden image” or CAD layout.

Furthermore, existing equipment may execute a locator algorithm to refine an estimate of joint location in the image. With the location known, the region around the joint is sampled to estimate the background, so that joint measurements can be compensated. Difficulty arises with this approach in that the operation of the locator algorithm can be impaired by shadowing, or by imperfections in the very joint under inspection. Furthermore, the pixels selected by dead-reckoning under such a locator algorithm may be contaminated by solder bridges or other joint structures.

Generally, an automated inspection system classifies objects based on measurements taken of the object being inspected. An objective or goal of the classification task performed by such systems is to use the measurements and/or combinations of the measurements of the object to determine whether a solder joint or the like is “good” or “bad”. Typically, measurements of the inspected joint are compared either to measurements taken of known good and bad objects or to specifications defining good and bad objects and a determination of class membership (as good or bad) is made. No single measurement can be used to reliably perform categorization. Instead, multiple measurements are often required. The measurements and/or combinations of the measurements, commonly known as features of the object, are compared to sets of representative features for each of the possible groups and a determination is made based on aggregate of the comparison results.

For automatic inspection of solder joints using an imaging system such as a laminography system, the goal is to correctly detect bad solder joints so that they can be flagged and not end up in a finished PCB. A simultaneous goal is to avoid incorrectly labeling good joints as bad joints since this would cause unwarranted increases in PCB production costs. There is a certain amount of acceptable variability in a good solder joint. This variability has various causes, such as a slight shifting of a lead relative to a circuit board's pad. Conversely, there are certain features of a bad joint that distinguish it from a good joint, for example, insufficient solder, excess solder, non-wetting, and shorts. A successful automated visual inspection system should produce images which capture these differences in a way that can be measured by a computer algorithm. The essential diagnostic characteristics of the joint image are distilled into a relatively small number of measurements, which are also known as features. The process of deriving the features is also known as feature extraction. Some examples of such features are the lateral extent of a joint, and estimates of the amount of solder in the heel, and in the toe of a joint. Ideal features vary only slightly due to acceptable variations, but exhibit a very different value in the face of one or more pathologies. However, in practice, any given feature exhibits some degree of overlap between good and bad indicators. Several features, perhaps numbering in the dozens of features, may need to be analyzed, in concert, to reliably catch all pathologies while passing acceptable variations.

Since experience has shown that no single measurement or feature correlates sufficiently well with whether a solder joint is good or bad, it is necessary to consider a number of features as an aggregate to distinguish good joints from bad joints. It is hoped that if a solder joint is bad, it will clearly fail or be classified as bad for at least one feature. High accuracy of pass/fail calls require that feature vectors of good joints be quite tightly clustered. Yet, the varying gain and shadows superimposed on laminographic joint images tend to scatter such measurements in such a manner that feature vectors of good and bad joints become commingled. In this situation, highly accurate inspection becomes difficult or impossible.

Existing use of algorithms for decomposing structuring elements (SEs) into a sequence of smaller ones is discussed in relation to image processing in numerous references. Jiarning Xu, Decomposition of Convex Polygonal Morphological Structuring Elements into Neighborhood Subsets, 1991 IEEE Transactions on Pattern Analysis and Machine Intelligence, Vol. 13, No. 2, pgs. 153-162, February 1991; and a paper by Hashimoto et al., discusses algorithms for decomposing convex binary structuring elements. Maragos, et al., Morphological Systems for Multidimensional Signal Processing, IEEE, Vol. 78, No. 4, pgs. 690-710, April, 1990, shows examples for which the computational complexity of applying such a decomposed structuring element transition from quadratic to linear in the size of the operator. A chamfering erosion algorithm is known, having been published in H. G. Barrow, et al., Parametric Correspondence and Chamfer Matching: Two New Techniques for Image Matching, IJCAI, pgs. 659-663, 1977. The context of this article is creating an image in which pixels are encoded a distance to the nearest “edge” pixel of a given binary image. The initial distant binary image is initialized with maximum value in all pixels; then zeroes are written into the pixels that were considered “edge”. Eroding this binary image using mathematical morphology produces a map of the distance from each pixel to the nearest edge pixel. The use of morphological operations to remove background streaks in images of biomedical gel stains was reported in Sternberg, Biomedical Image Processing, IEEE Computer, p.22-34, January 1983. Ioannis Pitas Fast Algorithms for Running Ordering and Max/Min Calculation, IEEE Transactions on Circuits and systems, p. 795-804, June 1989, analyzes a flat, rectangular SE computation, arriving at a logarithmic algorithm. However, this derivation is relatively complicated and difficult to program.

An extremely fast raster scan method for dilating by a linearly-sloped structuring element of infinite lateral extent is the chamfering algorithm, which was first disclosed in Rosenfeld, A. and Pflatz, J. L., Distance Functions on Digital Pictures, Pattern Recognition, Vol. 1 No. 1, July 1968, p.33-62. This method was repeated in Danielson, Euclidean Distance Mapping, Computer Graphics and Image Processing, Vol. 14, pgs. 227-248, 1980; and embodied in the teachings of Davis, U.S. Pat. No. 5,960,127. Gil & Werman, Computing 2-D Min, Median, and Max Filters, 1993 IEEE Transactions on Pattern Analysis and Machine Intelligence, Vol, 15, No. 5, pgs. 504-507, May 1993, introduced a new, very fast method of dilating in one dimension by a flat structuring element of limited extent, and it can be used for applying a flat, rectangular structuring element to an image. Gil et al., Efficient Dilation, Erosion, Opening, and Closing Algorithms, IEEE Transactions on Pattern Analysis and Machine Intelligence, Vol. 24, No. 12, pgs. 1606-1617, December 2002, makes some improvements in computation time to this method.

### BRIEF SUMMARY OF THE INVENTION

The present invention is directed to systems and methods for removing shadows from digital images, particularly grayscale images. The present invention may be used to deshadow a laminographic image so that element inspection can proceed with more stable and well-clustered features. The present invention makes use of the operations of mathematical morphology to erase shadowing effects of out-of-focus objects in a laminograph or radiograph. This invention is particularly well suited for the inspection of printed circuit boards, and/or solder joints of components disposed thereupon. Advantageously, an exponential propagation algorithm may be used in accordance with the present invention for rapid evaluation of morphological operators.

Compensation for shadowing in accordance with the present invention produces cleaner, more consistent features to be used for joint classification enabling high accuracy inspection. Advantageously, relative to previous compensation methods, the present deshadowing systems and methods do not require use of a joint locator algorithm prior to compensation. In accordance with embodiments of the present invention deshadowing may be applied to an image uniformly. However, deshadowing may be accomplished more quickly if it is applied only to a region of an image containing solder joints. As a further advantage, a joint locator algorithm run after deshadowing may be simpler, faster, and more accurate. Further, the present invention enables decoupling of feature extraction from background compensation, enabling use of a simpler algorithm for each.

After deshadowing, solder may be distinguished from the background by a pixel value analysis. Thus, an explicit locator algorithm may become unnecessary. Also following deshadowing, solder joints may be isolated by thresholding and connected region extraction. This enables feature extraction to be restricted to the actual area of solder, without inclusion of pixels from off-joint regions. Also, deshadowing may advantageously enable a solder bridge or the like to be specifically detected as a large connected region which extends over positions expected for two joints.

As mentioned above, advantages of deshadowing, relative to existing compensation methods, include that deshadowing is carried out before joint location. The present deshadowing systems and methods do not require prior knowledge of joint location in order to operate, although rough knowledge of joint location can be used to focus attention on the general region in order to reduce computation time. While deshadowing makes a joint locator algorithm's task easier, deshadowing also enables a joint locator algorithm to be replaced by the aforementioned thresholding and connected region extraction. Advantageously, such connected region extraction isolates the pixels of the solder from the background so that feature extraction is more focused and accurate and solder bridges become more obvious. Connected region extraction of a deshadowed laminograph results in more consistent extracted features, improving inspection accuracy.

The present invention applies operations from the mathematical morphology family as detailed below to establish a background level of a laminograph or other image. Mathematical Morphology employs a morphological operator that in turn involves a structuring element. A method for deshadowing a laminographic image may comprise selecting a mathematical morphology structuring element larger than examination elements of a laminographic image to be inspected, performing a mathematical morphological process on the image, and differentiating a background of the image from the features to remove the background.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 is a fragmented illustration of a prior art laminograph showing an integrated circuit (IC) soldered to a circuit board;

FIG. 2 is an illustration of the fragmented laminograph of FIG. 1 wherein the laminograph has undergone deshadowing in accordance with the present invention;

FIG. 3 is a flow chart of an embodiment of solder joint inspection using the present laminograph deshadowing method;

FIG. 4 is a flow chart of an embodiment of dilation of an image using a power-of-two structuring element in accordance with embodiments of the present laminograph deshadowing methods;

FIG. 5 is a flow chart of another embodiment of dilation of an image using a bi-directional power-of-two structuring element embodiment of the present laminograph deshadowing method;

FIG. 6 is a flow chart of an embodiment of the present laminograph deshadowing method;

FIG. 7 is a flow chart of an embodiment of a “fast” method of dilating an image using a terraced structuring element in accordance with the present invention;

FIG. 8 is a flow chart of a smoothly sloped structuring element embodiment of the present laminograph deshadowing method, showing computation of dilation by a sloped structuring element; and

FIG. 9 is a flow chart of a structuring element decomposition embodiment of the present laminograph deshadowing method.

### DETAILED DESCRIPTION

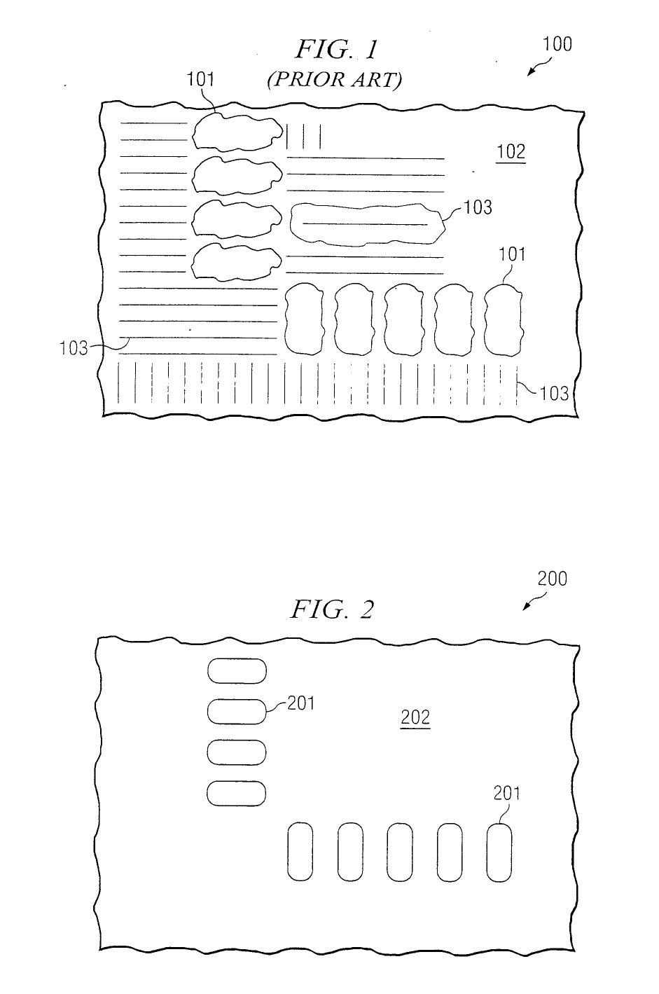

FIG. 2 shows a fragment of a deshadowed laminograph 200 resulting from application of the present systems and methods to prior art laminograph 100 of FIG. 1. In FIG. 2, the mass of solder joints 201 are clear against a background of circuit board 202.

In accordance with the present invention, a background level of a laminograph or other image is established by the highest transmission (lightest grayscale) in the immediately surrounding area by applying operations from the mathematical morphology family as discussed in greater detail below. As discussed in Maragos, et al., cited above, mathematical morphology employs a morphological operator that in turn involves a structuring element, S, where S=[S_{u,v}], with u and v being rectangular dimensions, in pixels, of structuring element S, where:
u₁≦u≦u₂, and (1)
v₁≦v≦v₂, and (2)
S_{u,v}≧0 (3)
where typically
u₁=−u₂ and (4)
v₁=−v₂. (5)

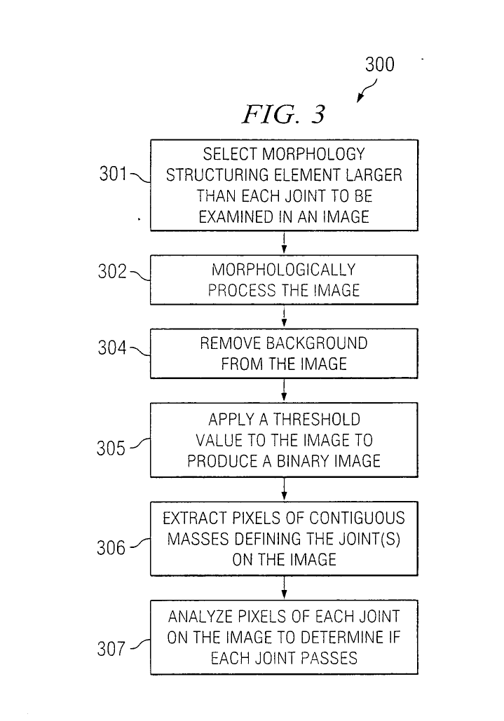

Turning to FIG. 3, a flow chart for an exemplar method of a solder joint, or other examination element, inspection employing an embodiment of laminographic deshadowing is shown. A morphological structuring element, S, which is bigger than the joints or elements to be examined is selected at box 301. S should be larger than the shortest dimension of a joint or examination element. S should be of limited width overall, typically approximating the lead-to-lead pitch. The lead-to-lead spacing for an IC can be used to size structuring elements. However, the other dimension of structuring element S should be comparably large, to extend beyond solder bridges or other large structure shadows. Also, S should be convex, downward (its 2nd derivatives being non-negative). S should also be fairly flat over the region sized to the smaller dimension of the joint. Beyond this central fairly-flat core, S preferably rises smoothly, to avoid introducing discontinuous artifacts into the image.

Herein, the following mathematical conventions are used. An image matrix, denoted by a capital letter, such as A, contains elements denoted by the corresponding lower-case letter, with subscripts, such at aᵢⱼ for appropriate values of i and j, occupying the i^{th} row and j^{th} column. Also, a superscript in parentheses denotes a generation number. For example in a computer program, A⁽⁰⁾ is the original content of image matrix A; A⁽¹⁾ is the content of A after the first set of operations; A⁽²⁾ is the content after the second set of operations, etc.

At box 302, given grayscale image, A, of solder joints or the like, a background grayscale image, B, is calculated by processing the morphological dilation of grayscale image A to structuring element S, B=A⊕S Therefore, given structuring element S and input grayscale image A, B, the dilation of A by S, B=A⊕S is computed as:

$${b}_{ij} = {{max}_{{u}_{1} \leq u < {u}_{2}}}_{{v}_{1} \leq v < {v}_{2}} ( {a}_{i - u , j - v} - {s}_{u , v} ) \qquad ( 6 )$$

where bᵢⱼ is the element of image B occupying the i^{th} row and j^{th} column, and a is similarly an element of image A.

If a subject laminograph appears as a negative, such that the denser darker solder produces higher gray values, then the erosion of grayscale image A to structuring element S may be used to calculate the background grayscale image by C=A⊖S. The erosion of A by S, C=A⊖S, may be computed as:

$${c}_{ij} = {{min}_{{u}_{1} \leq u < {u}_{2}}}_{{v}_{1} \leq v < {v}_{2}} ( {a}_{i + u , j + v} + {s}_{u , v} ) \qquad ( 7 )$$

Alternatively, B=A·S, the morphological closing of grayscale image A to structuring element S may be used to calculate background grayscale image B. The closing operator may be preferred, because it may give a more accurate result. However, calculation of the background using the closing operator may require greater computational effort. For negative images, the opening of grayscale image A to structuring element S, B=A∘S, may be preferred to obtain the background grayscale image, B. A·S is defined to mean (A⊕S)⊖S, and A∘S is defined as (A⊖S)⊕S.

In cases where i±u or j±v falls outside of the domain of A, the term may be ignored. The min operator takes the minimum of a group of terms. So, if for a particular combination of values of i, j, u, and v there is no a_{i+u,j+v}, then the term a_{i+u,j+v}+S_{u,v} may be ignored. As a result, there should be no undesirable edge effects, as there would be with linear convolutions similarly applied to a digital grayscale image.

The structuring element may be flat-bottomed, i.e., S_{u,v}=0 for all u and, v in the structuring element. The structuring element might be rectangular where:

$${S}_{u , v} = \{ \begin{matrix}0 & if {u}_{1} \leq u \leq {u}_{2} , {v}_{1} \leq v \leq {v}_{2} \\ ∞ & otherwise\end{matrix} \qquad ( 8 )$$

or the structuring element may be circular with a radius r, where:

$${S}_{u , v} = \{ \begin{matrix}0 & if {u}^{2} + {v}^{2} \leq {r}^{2} \\ ∞ & otherwise\end{matrix} \qquad ( 9 )$$

Additionally, as discussed above S should be larger than the shortest dimension of a joint or examination element but of limited width overall, typically approximating the lead-to-lead pitch. S should be convex downward, and should be fairly flat over the region sized to the smaller dimension of the joint, while beyond the fairly-flat central core, S preferably rises smoothly.

Also, the value in the “otherwise” clause need not be infinity, only sufficiently large relative to the image under examination, any value larger or equal to than the largest possible pixel value will preferably have no effect, as long as one of the entries for S_{u,v} is zero. Generally, assume that S_{0,0}=0. For if S_{0,0}=0, then
bᵢⱼ≧aᵢⱼ≧cᵢⱼ. or (10)
(A⊕S₎ᵢⱼ≧aᵢⱼ≧(A⊖S)ᵢⱼ (11)
Additionally,
(A⊖S₎ᵢⱼ≦(A∘S₎ᵢⱼ≦(A·S₎ᵢⱼ≦(A⊕S)ᵢⱼ (11a)

A difference between the solder joints or other examination elements and the background is estimated, at box 304 and the background is removed to produce deshadowed image C: C=B−A. This operation may result in reversal of polarity in images such as laminographs and radiographs, such that greater pixel values in grayscale image C represent greater density, and joints or the like are then displayed lighter than the background. If the original image was in a polarity which already had joints or elements displayed as lighter than the background, then the background may be estimated by morphological opening B=A∘S and the deshadowed image may be calculated by C=A−B.

Thus the present systems and methods employ knowledge of the expected sizes of the objects to be imaged in order to construct one or more morphological filters and apply these filters to a laminograph to remove background shadows. With the background thus removed, further inspection using the image may proceed. FIG. 3 also depicts steps (305-307) such an inspection might employ. The solder regions may be isolated by thresholding at box 305 using a threshold pixel value, T, wherein resultant binary image D=C>T. In other words, a given pixel of binary image D is one if the corresponding pixel of C is greater than T, and is zero otherwise. Contiguous regions of ones may then be extracted from the resulting binary image D at box 306 to find masses of solder. Each connected region which lies at an expected joint position may be taken to define the pixels that represent a joint. At box 307, these regions are measured to yield features that indicate whether each joint is “good” or “bad”. Features directly obtainable from the connected regions of D include, for instance, the position, lateral extent, overall area, and projective (two-dimensional) shape of the solder joint. The region's corresponding pixels of deshadowed image C can also be analyzed to give the total amount of solder in the joint, as well as its distribution. Established techniques of decision theory may be applied to these features to classify the joint as “good” or “bad”.

Morphological operators include the aforementioned closing, A·S=(A⊕S)⊖S, and further, opening, A∘S=(A⊖S)⊕S. These operators are idempotent, i.e., (A·S)·S=A·S and (A∘S)∘S=A∘S.

Direct computation of morphological operators according to the defining equations (6) and (7), above may be quite time consuming. To dilate an N×M image by a u×v structuring element implies M×N×u×v difference operations, and the same number of max operations. One alternative method embodiment for reducing the computational load, in accordance with the present invention, is to sparsely sample the structuring element. For example, using a structuring element where only the entries on the diagonal, or only entries along the horizontal and vertical midlines, or a similar set of entries are considered significant. This reduces the computational load to M×N×(u+v) operations, or to M×N×max(u,v), depending on how the operation is performed. Thus, much computational speed is gained, at a cost of additional artifacts in a resulting image. At the cost of doubling the computational effort, one may reduce the artifacts by following the dilation by the corresponding erosion, the two operations constituting a closing operation.

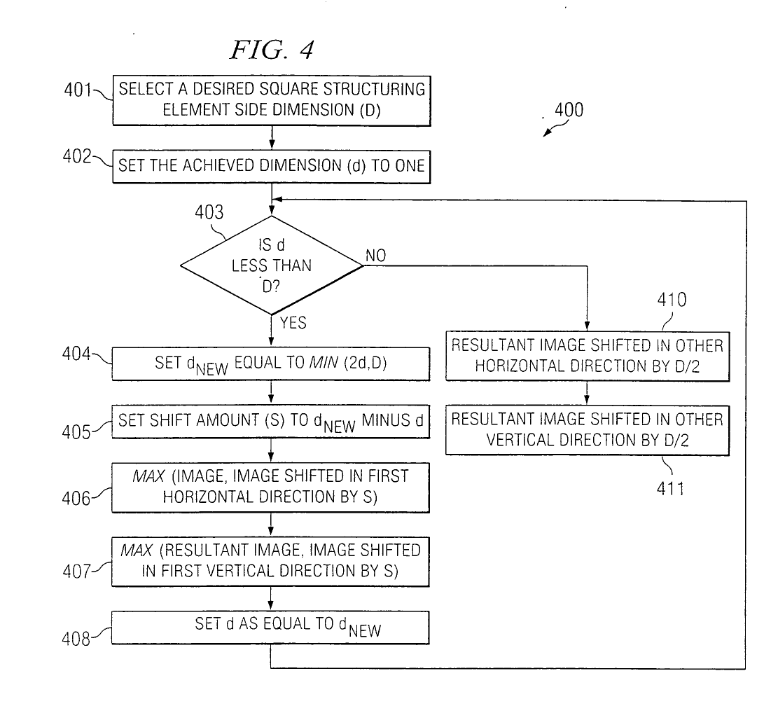

FIG. 4 is a flow chart of power-of-two structuring element embodiment 400, employing a flat-bottomed rectangular structuring element. A square structuring element side dimension (D) is chosen at box 401 and the dimension achieved (d) by the dilation is initially set to one at box 402. If it is determined at box 403 that the achieved dimension is less than the structuring element side dimension chosen then a new achieved dimension (d_{new}) is set equal to min(2d, D) at box 404. At box 405 a shift amount (s) is set to be equal to the new achieved dimension, less the achieved dimension (s=d_{new}−d). If grayscale image array, A, is very large, such that edge effects are not a concern, the operation:
A⁽¹⁾←max(A,A [symbol] 1) (12)
may be performed at box 406, where A [symbol] 1 denotes A shifted to the right one pixel, i.e.:
aᵢⱼ⁽¹⁾=max(aᵢⱼ,a_{i,j-1}) (13)
this is followed by shifting the result down against itself and applying the maximum operation at box 407:
A⁽²⁾←max(A⁽¹⁾,A⁽¹⁾ [symbol] 1) (14)
where this is understood to mean:
aᵢⱼ⁽²⁾=max(aᵢⱼ⁽¹⁾,a_{i,j-1}⁽¹⁾) (15)

These operations may be performed on grayscale image A, in place, with A⁽¹⁾, A⁽²⁾, etc. referring to subsequent generations of the contents of the same grayscale image array, A. The achieved dimension (d) is increased to the new achieved dimension (d_{new}) at box 408. After these steps, each entry is the “max” of four neighbors of the original image:

$${a}_{ij}^{( 2 )} = {{max}_{0 \leq u < 2}}_{0 \leq v < 2} {a}_{i - u , j - v} \qquad ( 16 )$$

The operations of boxes 404, 406, and 407 may be repeated with the shift amount increased at box 405. For example with a shift of two as follows:
A⁽³⁾←max(A⁽²⁾,A⁽²⁾ [symbol] 2) (17)
A⁽⁴⁾←max(A⁽³⁾,A⁽³⁾ [symbol] 2) (18)
which is equivalently, elementwise to:
aᵢⱼ⁽³⁾=max(aᵢⱼ⁽²⁾,a_{i,j-2}⁽²⁾) (19)
aᵢⱼ⁽⁴⁾=max(aᵢⱼ⁽³⁾,a_{i-2,j}⁽³⁾) (20)
Now in terms of the original contents:

$${a}_{ij}^{( 4 )} = {{max}_{0 \leq u < 4}}_{0 \leq v < 4} {a}_{i - u , j - v} \qquad ( 21 )$$

Again, repeating steps 404-407 the array may be shifted against itself by four:
A⁽⁵⁾←max(A⁽⁴⁾,A⁽⁴⁾ [symbol] 4) (22)
A⁽⁶⁾←max(A⁽⁵⁾,A⁽⁵⁾ [symbol] 4) (23)
producing:

$${a}_{ij}^{( 6 )} = {{max}_{0 \leq u < 8}}_{0 \leq v < 8} {a}_{i - u , j - v} \qquad ( 24 )$$

At each iteration, the image is shifted against itself in each direction by the next power-of-two and the max taken at boxes 406 and 407 until the achieved dimension is equal to or greater than the chosen dimension. With each iteration, the area of influence of any given image pixel quadruples. Thus, the computation per resultant pixel is logarithmic in the size of the square region defining the structuring element. Steps 404 and 405 ensure that the cumulative effective SE grows as a power of two until a last loop, where the SE grows to the specified size. If the selected SE happens to be a power of two in size, then in step 404, 2d and D will be the same in the last loop.

Implicitly, the structuring element for this embodiment has its corner, not its center, but on the origin (offset: 0,0) of the structuring element. This offsets the results. Since the structuring element dimensions are powers of two, the center is on a corner between four pixels. The resulting image may be extracted from the shifted result by shifting the resulting image left by one half of the chosen structuring element dimension at box 410 and shifting the image up by one half of the chosen structuring element dimension at box 411. However, the result is misregistered by half a pixel vertically and horizontally.

Also, it is not necessary under this embodiment to apply power-of-two shifts every time. Similarly, the resulting structuring element is not required to have power-of-two dimensions. To obtain a structuring element of width twenty-five, shifts of one, two, four and eight may be applied to reach width of sixteen, and then a final shift of nine may be applied to reach a width of twenty-five. If the final width is odd, then the structuring element's center falls directly on one of its elements, and there is no one-half pixel shift in the result.

Similarly, the order of shift application does not matter. An operator of width twenty-five may be obtained by applying shifts in the order nine, eight, four, two and one or two eight, four, one and nine, or the like. Horizontal shifts may all be applied before vertical shifts, or vice versa, or horizontal and vertical shifts may be interleaved.

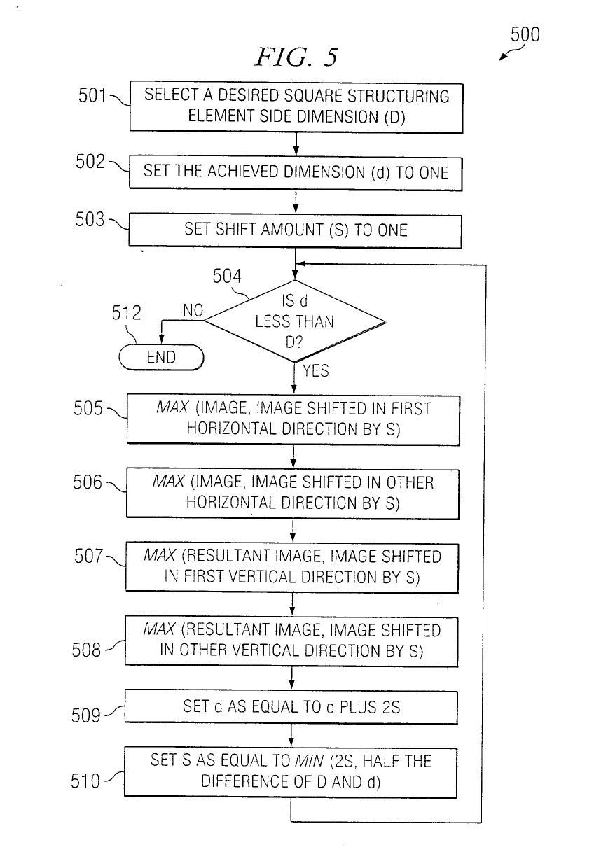

Alternatively, as shown in FIG. 5, illustrating a second square, flat-bottomed structuring element embodiment 500 of the present invention, at each step the image may be shifted, both left and right and up and down, against itself. This doubles the computational work at each step for nearly equivalent structuring element widths, but eliminates one step of the mathematical morphology processing task. A square structuring element side dimension (D) is chosen at box 501 and the dimension achieved (d) by the dilation is initially set to one at box 502. At box 503 a shift amount (s) is set to be equal to one. If it is determined at box 504 that the achieved dimension (d) is less than the structuring element side dimension (D) chosen, then the max of the image is taken, shifting the image to the right by the shift amount (s) at box 505. Then the max of the image is taken, shifting the image left by the shift amount (s) at box 506. Next, the max of the resulting image is taken at box 507, shifting the image down upon itself by the shift amount (s). Then the max is taken, shifting the image up at box 508 by the shift amount (s). The achieved dimension (d) is then increased by double the shift amount (s) at box 509. Then at box 510 the shift amount (s) is increased to the minimum of twice the previous shift amount (2s), and half the difference between the desired (D) and achieved (d) structuring element diameter, or (D−d)/2. The shifts of boxes 505-508 and adjustments in the achieved dimension and shift amount of boxes 509 and 510 are repeated until the achieved dimension (d) is equal to, or greater than, the chosen structuring element dimension (D) at box 504, whereupon method 500 ends at 512.

If shifts are applied symmetrically in both directions, the region of influence, or support of the structuring element spreads by a power-of-two in both directions, left and right, or up and down, at each step. However, the regions of influence of opposed directions overlap by one pixel, so the operator width is one pixel less than a power-of-two. This also applies to non-power-of-two shifts. To get a width of twenty-five, shifts both ways of one, two, four and five may be used. This enables performing the operation in-place, without using auxiliary storage to hold transient images.

Alternatively, the amount of “spreading” does not need to be symmetrical., the same in both directions. For example, two stages may be applied horizontally and four stages applied vertically, so that the structuring element is four wide by thirty-one.

It is also not necessary under this embodiment to apply power-of-two shifts every time. Similar to embodiment 400 above, the resulting structuring element is not required to have power-of-two dimensions. The order of shift application does not matter in embodiment 500 as well. Horizontal shifts may all be applied before or after vertical shifts or interleaved.

In a closing embodiment of the present invention, the morphological closing operator may be used. This consists of a dilation, as above, followed by an erosion. Erosion is the same as dilation except that the minimum operator is applied at boxes 406 and 407, or boxes 505, 506, 507 and 508, above, rather than the maximum; and the direction of the shifts is reversed. For embodiment 400, this enables a second 1/2 pixel shift to be performed in the opposite direction, so that the two 1/2 pixel shifts cancel each other (embodiment 500 has no 1/2 pixel shift).

Closing uses twice as much computational power as dilation, but it reduces the area of influence of an anomalously bright pixel. Either closing or dilation tends to break an image up into discontinuous regions if a flat-bottomed structuring element is used, but the regions are smaller when the closing operator is used.

Under this closing embodiment, care must to be taken to ensure that the structuring element is larger than the solder joint. If the structuring element is not larger than the solder joint, the joint will not be bridged and the erosion step will reenlarge it. Thus, the penalty for undersizing the structuring element is greater for closing than for dilation.

Advantageously, opening as in above disclosed embodiments 400 and 500, or closing as with this embodiment, results in an image that is registered with the original image, even if the structuring element is asymmetrical. Also, if the background varies more slowly than the structuring element, then the background is preserved by closing. This is not typically true of dilation by itself, nor of erosion by itself.

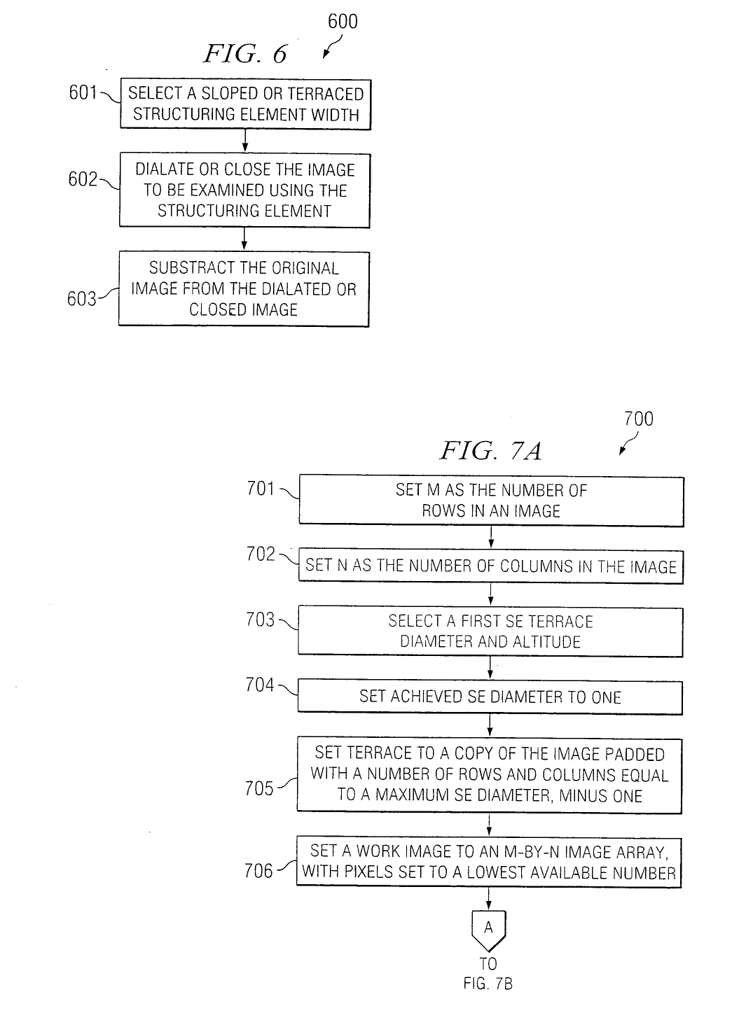

With a flat structuring element sharp boundaried zones may be caused by small bright objects. Embodiment 600 of the present invention, as flow charted in FIG. 6, ameliorates this effect. The transitions can be greatly softened by averaging the dilated image with an image, which has been dilated employing a structuring element half the width. This approximates the effect of a rounded structuring element. At box 601, an SE is selected that is wide enough to bridge solder joints, and that is sloped or terraced appropriately to let its influence fade out, to avoid discontinuity artifacts. The image is dilated or closed using the structuring element at box 602. The original image is subtracted form the resulting image at box 603.

A rounded-bottom structuring element embodiment, using dilation or closing, serves to produce an estimate of the background signal level of the circuit board surrounding solder joints. The variability of background level across the image comes from variable gain in the imaging system, and from shadowing of components of the other side of the board. With these influences removed, the image much more clearly depicts the solder joints themselves. Thus, separation of solder from non-solder by thresholding the density, as discussed above, is even more effective. Connected region extraction can then be more effectively used to isolate the joints and features extracted from the joints become more accurately diagnostic of the quality of the joints.

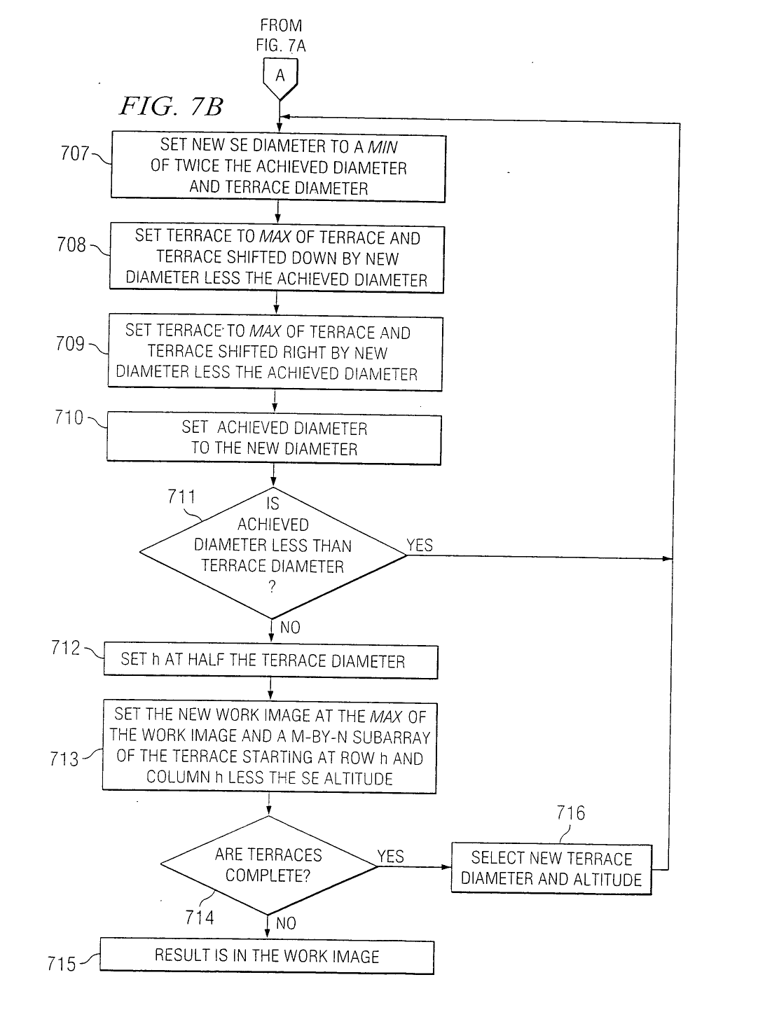

In a terraced structuring element embodiment, a structuring element's influence preferably rounds off at the edges of the image. This can be approximated by an invertedly terraced structuring element. Method 700 of deshadowing, employing such a terraced structuring element, is flow charted in FIG. 7. Dilation by such a terraced structuring element can be accomplished by an extension of the previous methods. For example, to dilate image A by a structuring element which has a central terrace of height zero and diameter fifteen, surrounded by a terrace of height four and diameter twenty-five, with an outside terrace of height nine and diameter of thirty-three. With reference to FIG. 7, the following steps are flowcharted for the full algorithm for employing multiple terraces to carry out the present invention. At 701 M is set as equal to the number of rows in a laminograph or similar image to be deshadowed. At 702 N is set as the number of columns in the image. A first terrace diameter and terrace altitude for the Structuring Element (SE) is selected at 703. At 704 the achieved diameter of the structuring element is set at one. At 705 the terrace is set as equal to a copy of the image, padded by the number of rows and columns equal to a selected maximum diameter of the SE, minus one. The number of rows and columns are set preferably set to the lowest available number for the image. A workimage is set as equal to the M by N image array, with pixels set to the lowest available number at 706. A new diameter of the SE is set at 707 as the min of two times the achieved diameter, terrace diameter. At 708 the terrace is set to the max of the terrace, terrace shifted down by the new diameter from 707 less the achieved diameter. At 709 the terrace is set to the max of the terrace, terrace shifted right by the new diameter from 707 less the achieved diameter. Then at 710 the achieved diameter is set as equal to the new diameter set at 707. A determination is made at 711 as to whether the achieved diameter is less than the terrace diameter. If it is steps 707 through 711 are repeated. If the achieved diameter is greater than or equal to the terrace diameter at 711, the terrace half-width (“h”) is set to half of the terrace diameter. Then at 713 a new workimage is set equal to the max of the old workimage from 706, an M by N subarray of terrace starting at row h column h less the altitude of the SE. If it is determined at 714 that all the terraces to be used have been used the result is found in the workimage at 715. However, if there is another terrace to be used the terrace diameter and altitude are selected at 716 and steps 707 through 714 are repeated.

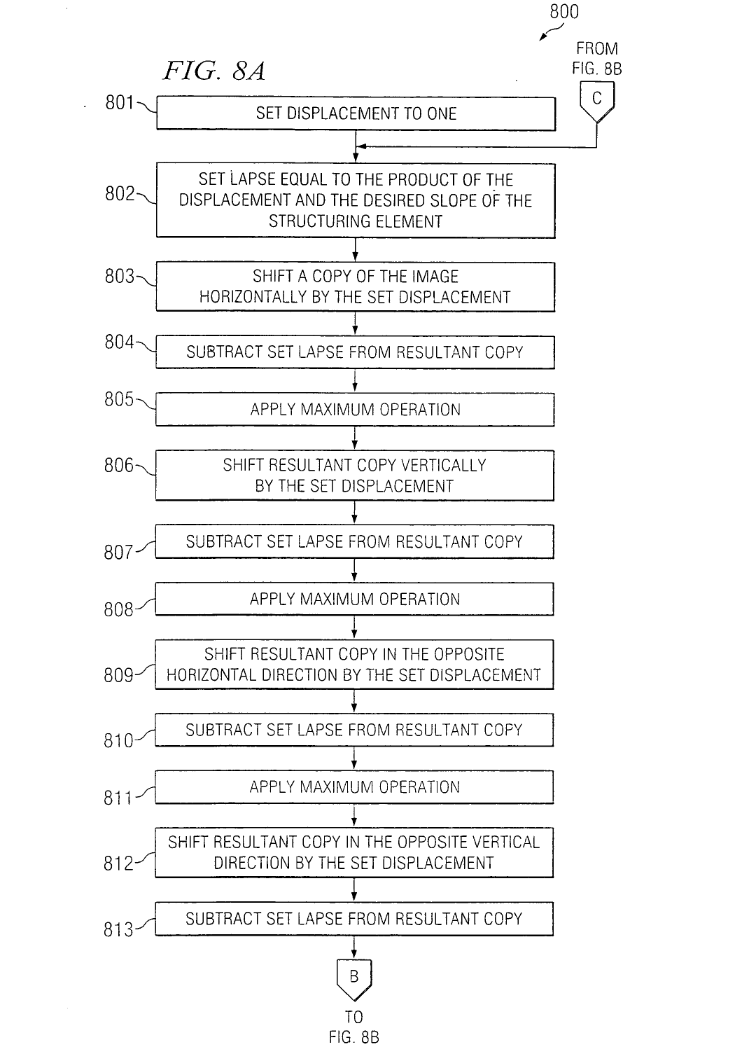

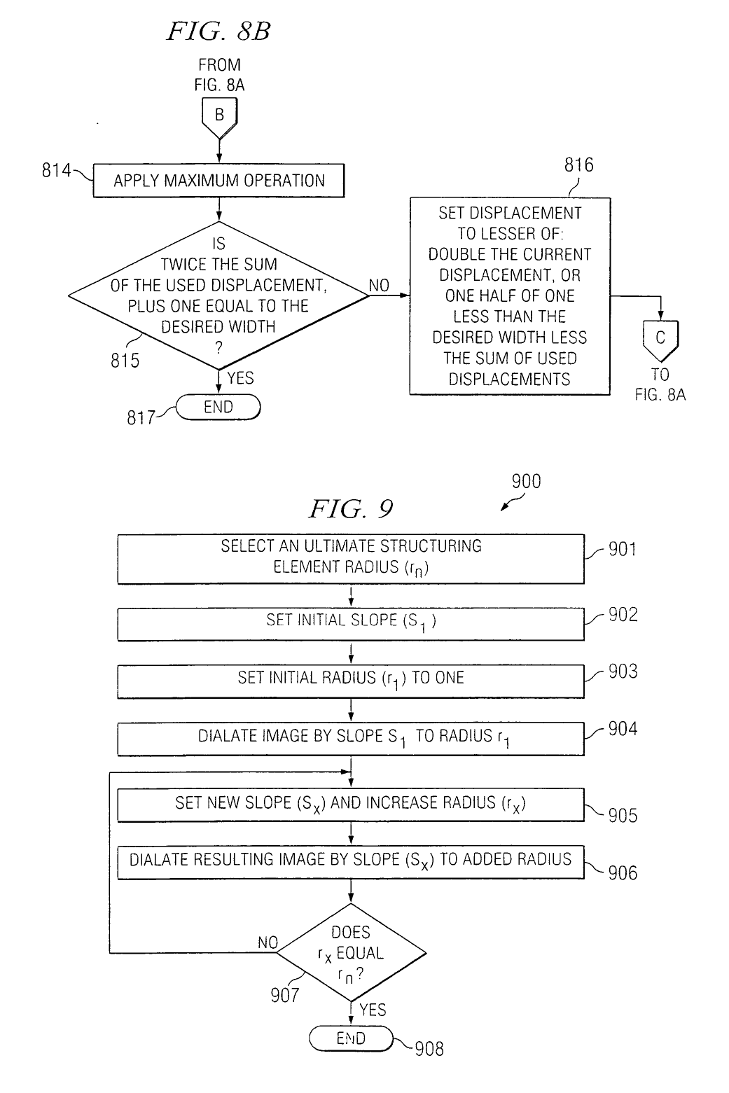

In the above terraced structuring element embodiment of the present invention, if the structuring element needs to be smoothly rounded off, several terraces may be necessary. However, an embodiment with a structuring element having a smoothly varying surface of constant slope may be implemented by method 800, as shown in FIG. 8. A practical structuring element may be a four-face, inverted pyramid, with each face sloping up from the center. Assuming that grayscale image A is represented in floating point, or scaled integer, such that there are fractional bits available, the individual pixels of image A may be shifted left within their registers before operation to achieve fractional bits, then shifted right afterward. That is, each pixel is multiplied by some factor (such as 16, to achieve 4 fractional bits), an operation is carried out, and then each pixel is divided by the same factor. To dilate grayscale image A by an operator of slope s, the following is performed. An achieved displacement (d) of one is set at 801. Then, at box 802 a lapse is computed to be equal to the product of the displacement and the desired slope of the SE. A copy of image A is shifted horizontally (right in the example below) by displacement (d) at 803. The lapse is subtracted from the resulting image at 804, and at 805 the maximum operation is applied:
A⁽¹⁾=max(A, (A [symbol] d)−d·s) (25)
Then, at box 806 resultant image A⁽¹⁾ is shifted vertically (up in the example below) by displacement (d), at 807 the lapse is subtracted from the resulting image and the maximum operation is applied at 808:
A⁽²⁾=max(A, (A [symbol] d)−d·s) (26)
Then, at box 809 resultant image A⁽²⁾ is shifted in the opposite horizontal direction (in the example, left) by displacement (d), the lapse is subtracted at 810 and the maximum operation is applied at 811:
A⁽³⁾=max(A, (A [symbol] d)−d·s) (27)
Then, at box 812 to achieve image A⁽⁴⁾, resultant image A⁽³⁾ is shifted in the opposite vertical direction (in this example, down) by displacement (d), then at 813 the lapse is subtracted from the resultant image and the maximum operation is applied at 814:
A⁽⁴⁾=max(A, (A [symbol] d)−d·s) (28)
If it is determined at box 815 that twice the sum of the achieved displacements, plus one, is less than the desired structuring element diameter, the displacement is reset at box 816. The displacement is reset at 816 to be twice the current displacement but limited so that twice the sums of the achieved displacements plus one is less than or equal to the desired SE width. In other words the displacement is set to the lesser of twice the current displacement or one half of one less than the desired SE width, less the sum of the achieved displacements. and steps 802 through 814 are repeated on the resultant image. When twice the sum of the displacements made, minus one, is determined to be equal to the desired structuring element diameter at 815, the process ends at 817. Non-power-of-two operators may be obtained as explained above.

In the smoothly sloping structuring element embodiment, the facets of the structuring element lie between the Cartesian axes of the structuring element, centered on the diagonals of the structuring element. The stated slope, s, holds in the directions of the Cartesian axes, but the slope is s\sqrt{2} along the diagonals.

A piecewise-linear structuring element embodiment which employs a structuring element that is flat-bottomed and then rolls off on a slope, or with increasing slope may be employed. This can be achieved by combining the techniques of the terraced structuring element and smoothly sloped structuring element embodiments discussed immediately above or, the sloped embodiment can be used with the slope set to zero.

In accordance with the present invention, it is possible to apply both a chamfer, possibly multiple times, with the very fast method of dilating in one dimension by a flat SE of limited extent discussed above to produce a smoothly rolled off SE of limited width. Assuming that image A is expressed with fractional bits, such as floating point numbers, the chamfering dilation algorithm may be expressed as follows.
for i=1 . . . m and
   for j=1 . . . n
      Aᵢⱼ←max(Aᵢⱼ, A_{i-1,j}−s, A_{i,j-1}−s, A_{i-1,j-1}−s\sqrt{2}, A_{i-1,j+1}s\sqrt{2}) (29)
and for i=m . . . 1 by −1 and
   for j=n . . . 1 by −1
      Aᵢⱼ←max(Aᵢⱼ, A_{i+1,j}−s, A_{i,j+1}−s, A_{i+1,j-1}s\sqrt{2}, A_{i+1,j+1}−s\sqrt{2}) (30)
      where image A is an m×n array and s is the desired slope of the structuring element facet. Any terms referring to out-of-bounds elements of the image should be omitted from the expression of image A. The structuring element implied by this structuring element operator is an inverted 8-sided pyramid, with each face sloping up with slope, s at its edges, and somewhat more slope along its midline.

To compute a four-sided chamfer similar to the smoothly sloped structuring element embodiment, the terms involving \sqrt{2} may be omitted. As before, chamfering erosion is obtained by a slight modification of the algorithm. Add s or s\sqrt{2} rather than subtract, and use the min operator rather than the max above.

This chamfering algorithm can be more rapidly computed than other embodiments. It is smooth, and does not introduce sudden discontinuities. However, the implied structuring element has infinite support or region of influence, in that a very high value pixel can dominate the result all the way across the image. This, together with a constant slope, results in that after one dilation or erosion, no further dilations or erosions change the image. This also means that closing is equal to dilation, and opening is equal to erosion. However, if a solder joint is half-shadowed by an offset opaque object that is not highly blurred, the computed background has the transition offset so that the lighter background region gains at the expense of the darker background. Also, an anomalously bright noise pixel umbras a surrounding region, producing a bright splotch, which can not be removed by matching erosion.

A piecewise linear dilation or erosion by a structuring element decomposition embodiment employs dilation or erosion with a piecewise linear structuring element of limited support to overcome such half shadows and umbras. Embodiment 900 is flow charted in FIG. 9. Dilation or erosion with a piecewise linear structuring element is preferably simplified by decomposition of the structuring element in embodiment 900. This embodiment represents the structuring element as slope s₁ out to radius r₁, then slope s₂ out to radius r₂, . . . , slope sₙ out to ultimate radius rₙ, selected at 901. Thus, a structuring element diameter in embodiment 900 is twice the radius plus one. In accordance with embodiment 900, the following algorithm may be performed on image A. The initial slope is set to an appropriate value at 902. The initial slope (s₁) is set to zero for a flat bottom structuring element, or for the inner flat core of a smoothly varying structuring element at 902. An initial radius (r₁) of one is set at 903. At box 904 image A is dilated in place by initial slope, s₁, to initial radius r₁ per the above described embodiment 800. Then a new slope sₓ, is selected, such as s₂ for a second iteration, and the radius doubled or increased to rₓ, such as to r₂ for a second iteration, at 905. Then the resultant image is dilated in place by the new slope s₂(sₓ), to added radius r₂−r₁ (rₓ−r₁) at 906, per the above described embodiment 800. If a determination is made at 907 that ultimate radius rₙ, selected at 902 has not been reached, then the resulting image is again dilated in place at 906 by a new slope sₓ selected at 905 to radius rₓ−rₓ₋₁ until ultimate radius rₙ, selected at 902 has been reached, as determined at 907, whereupon process 900 ends at 908. Thus, at 905 the radius may not be doubled during a final iteration but only increased to ultimate radius rₙ.

Each successive slope (sₓ) will preferably be greater than its predecessor (sₓ₋₁) The inner slope may be zero, out to a diameter which is roughly equal to the width of a solder joint or other object of interest. This inner slope may be surrounded by segments, possibly one to three segments, of increasing slope, with the last overall width being comparable in size to the joint-to-joint pitch, or similar dimension. This embodiment lends itself to building composite structuring element's of differing slopes such as structuring elements with flat-bottomed regions. A flat-bottomed center of the structuring element can be achieved by setting s₁=0. Erosion can be decomposed in the same way.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for deshadowing a laminographic image comprising:
constructing one or more morphological filters using expected sizes of the objects to be imaged; and
applying said filters to a laminograpic image including images of said objects.

2. The method of claim 1 further comprising:
differentiating, after said applying, a background of said image from said images of said objects to remove said background.

3. The method of claim 2 further comprising:
thresholding an image resulting from said differentiating to provide a binary image of said objects.

4. The method of claim 3 further comprising extracting said image resulting from said thresholding to disclose pixels representing said objects.

5. The method of claim 1 wherein said morphological filter employs a dilation.

6. The method of claim 5 wherein said dilation uses a power of two structuring element.

7. The method of claim 5 wherein said dilation uses a bi-directional power-of-two structuring element.

8. The method of claim 5 wherein said morphological filter computes morphological operators such that the area of influence of the structuring element expands in a plurality of directions by up to a power of two during said computation.

9. The method of claim 5 wherein said dilation uses a terraced structuring element.

10. The method of claim 5 wherein said dilation uses a sloped structuring element.

11. The method of claim 10 wherein said structuring element is smoothly sloped.

12. The method of claim 1 wherein said morphological filter employs a closing.

13. The method of claim 1 wherein said image is a negative and said morphological filter employs an erosion.

14. The method of claim 1 wherein said image is a negative and said morphological filter employs an opening.

15. The method of claim 1 wherein said morphological filter employs an operation comprising decomposing a structuring element.

16. The method of claim 15 wherein said morphological filter employs an operation comprising at least one piecewise linear dilation by a structuring element of limited support.

17. The method of claim 15 wherein said morphological filter employs an operation comprising at least one piecewise linear erosion by a structuring element of limited support.

18. The method of claim 1 wherein said objects are solder joints.

19. The method of claim 18 wherein said solder joints are on a circuit board.

20. The method of claim 18 wherein a background of said laminographic image are out of focus shadows of said circuit board and components on said circuit board.

21. A method for deshadowing a laminographic image comprising:
selecting a mathematical morphology structuring element larger than examination elements of a laminographic image to be inspected;
performing a mathematical morphological operation on said image; and
differentiating, after performance of said mathematical morphological operation, a background of said image from said examination elements to remove said background.

22. The method of claim 21 wherein said mathematical morphological operation is a dilation.

23. The method of claim 21 wherein said mathematical morphological operation is a closing.

24. The method of claim 21 wherein said image is a negative and said mathematical morphological operation is an erosion.

25. The method of claim 21 wherein said image is a negative and said mathematical morphological operation is an opening.

26. The method of claim 21 wherein said performing a mathematical morphological operation comprises dilation of said image using a power of two structuring element.

27. The method of claim 21 wherein said performing a mathematical morphological operation comprises dilation of said image using a bi-directional power of two structuring element.

28. The method of claim 21 wherein said performing a mathematical morphological operation comprises computing morphological operators such that the area of influence of the structuring element expands in a plurality of directions by up to a power of two during said operation.

29. The method of claim 21 wherein said performing a mathematical morphological operation comprises dilation of said image using a terraced structuring element.

30. The method of claim 21 wherein said performing a mathematical morphological operation comprises dilation by a sloped structuring element.

31. The method of claim 29 wherein said structuring element is smoothly sloped.

32. The method of claim 21 wherein said performing a mathematical morphological operation comprises decomposing a structuring element.

33. The method of claim 31 wherein said performing a mathematical morphological operation comprises at least one piecewise linear dilation by a structuring element of limited support.

34. The method of claim 31 wherein said performing a mathematical morphological operation comprises at least one piecewise linear erosion by a structuring element of limited support.

35. The method of claim 21 wherein said performing a mathematical morphological operation comprises computation of morphological operators such that the area of influence of the structuring element expands in each direction by up to a power of two during said computation.

36. The method of claim 21 further comprising:
thresholding an image resulting from said differentiating to provide a binary image of said examination elements.

37. The method of claim 36 further comprising extracting said image resulting from said thresholding to disclose pixels representing said examination elements.

38. The method of claim 21 wherein said examination elements are solder joints.

39. The method of claim 38 wherein said solder joints are on a circuit board.

40. The method of claim 39 wherein said background comprises out of focus shadows of said circuit board and components on said circuit board.

41. A method for deshadowing a laminographic image comprising:
selecting an ultimate mathematical morphology structuring element radius larger than examination elements of a laminographic image to be inspected;
setting an initial slope for said structuring element;
setting an initial radius of said structuring element to one;
performing a mathematical morphological operation on said image by said set slope to said set radius to achieve a resulting image;
setting a new slope for said structuring element;
increasing the radius of said structuring element;
performing a mathematical morphological operation on said resulting image by the new slope to the increased radius to achieve a new resulting image; and
repeating said setting a new slope, increasing radius, and performing a mathematical morphological operation, on said new resulting image, if the increased radius does not equal said ultimate mathematical morphology structuring element radius.

42. The method of claim 41 wherein said mathematical morphological operation is a dilation.

43. The method of claim 41 wherein said mathematical morphological operation is an erosion.

44. The method of claim 43 wherein said image is a negative.
